(19) United States
(12) Patent Application Publication
(10) Pub. No.: US 2023/0096589 A1
(43) Pub. Date: Mar. 30, 2023

(54) FITTING FOR FURNITURE PARTS

(71) Applicant: Häfele Berlin GmbH & Co KG, Berlin (DE)

(72) Inventors: Lorenz Arnold, Unteraegeri (CH); Ulrich Merz, Regensburg (DE)

(73) Assignee: Häfele Berlin GmbH & Co KG, Berlin (DE)

(21) Appl. No.: 18/061,477

(22) Filed: Dec. 5, 2022

Related U.S. Application Data
(63) Continuation of application No. PCT/EP2021/061072, filed on Apr. 28, 2021.

(30) Foreign Application Priority Data
Jun. 8, 2020 (DE) DE202020103273.9

(51) Int. Cl. F16B 12/20

(52) U.S. Cl. CPC F16B 12/20

(57) ABSTRACT

A fitting for connecting two parts includes a cup-shaped housing for insertion into an open-edge bore in the one part. Two double-armed levers are connected in an articulated manner about an axis running, in the housing, parallel to the cup axis and which each have an inner lever arm which is arranged in the housing and an outer lever arm which projects outwards beyond the circumference of the housing and is intended for engaging in a surface-area bore in the other part. A handle can be moved from a starting position into an end position and has an actuating element for rotating the inner lever arms in relation to one another such that the two outer lever arms are spread further apart in the end position of the handle than in the starting position.

### CROSS-REFERENCE TO RELATED APPLICATIONS

This continuation application claims priority to PCT/EP2021/061072 filed on Apr. 28, 2021, which has published as WO 2021/249691 A1 and also the German application number 20 2020 103 273.9 filed on Jun. 8, 2020, the entire contents of which are fully incorporated herein with these references.

### DESCRIPTION

### Field of the Invention

The invention relates to a fitting for connecting two parts.

### Background of the Invention

Furniture connectors are well known and serve to fasten together two furniture parts which abut against one another at an angle, preferably at right-angles. Known furniture connectors have a rotatably mounted tightening element with a slot for a screwdriver, in order to rotate the tightening element after inserting the furniture connector into a surface-area bore of a furniture part and thus to engage behind and tighten a bolt which is fastened to a different furniture part.

Accordingly, it is the object of the invention to specify a furniture connector which can be actuated without the use of tools.

### SUMMARY OF THE INVENTION

This object is achieved according to the invention by a fitting for connecting two parts, comprising a cup-shaped housing for insertion into an open-edge bore in the one part, two double-armed levers which are connected in an articulated manner about an axis running, in the housing, parallel to the cup axis, and which each have an inner lever arm which is arranged in the housing and an outer lever arm which projects outwards beyond the circumference of the housing and is intended for engaging in a surface-area bore in the other part, and a handle which can be moved from a starting position into an end position and has an actuating element for rotating the inner lever arms in relation to one another such that the two outer lever arms are spread further apart in the end position of the handle than in the starting position.

In a preferred embodiment, the two double-armed levers are connected together in a scissors-like manner, i.e., crossing one another, wherein the actuating element cooperates with the inner faces of the inner lever arms, which face one another, in order to spread the two inner lever arms further apart in the end position of the handle than in the starting position. In another preferred embodiment, the two double-armed levers are connected together in the manner of spreading tongs, i.e., not crossing one another, wherein the actuating element cooperates with the outer faces of the inner lever arms, which face away from one another, in order to press the two inner lever arms further together in the end position of the handle than in the starting position.

Preferably, the actuating element has a spreading contour for spreading apart the two inner lever arms, or a pressing contour for pressing together the two inner lever arms.

Particularly preferably, the outer lever arms have, at their free ends protruding from the housing in each case on the outer face, at least one outwardly angled wedge nose and the inner lever arms have, at their free ends in each case on the outer face, at least one tooth which in the end position protrudes outwardly from the housing. In the end position, when the fitting is inserted into corresponding bores, the wedge noses and the teeth can be pressed into the bore walls and anchor the fitting therein.

Preferably, the housing has at least one circumferential tab, in particular two circumferential tabs which face one another in the housing circumferential direction and which are elastically deflected or elastically deformed outwardly by the inner lever arms when the handle is moved from the starting position into the end position. When moved from the starting position into the end position, the handle is moved counter to the elastic restoring force of the circumferential tab(s) into the end position and thus is pretensioned into the starting position.

In order to hold the handle in the end position, the inner lever arms preferably have in each case on the inner face a latching recess or a latching projection in order to latch the actuating element in the end position.

Particularly preferably, the handle is configured as a pivot lever which is mounted on the housing so as to be rotatable from the starting position into the end position. In a development, the pivot lever is configured to be double-armed and is mounted on the housing so as to be rotatable about an axis parallel to the rotational axis of the two levers. When the pivot lever is rotated into the end position, the two inner lever arms are actuated and the outer lever arms are spread apart thereby. For easy gripping, in the starting position the pivot lever can be lifted up by an angle relative to the housing front face. In another development, the pivot lever is configured to be single-armed and is mounted on the housing so as to be rotatable about an axis at right-angles to the rotational axis of the two levers. In this case, the actuating element is arranged on the lower face of the pivot lever and cooperates with the inner lever arms when the pivot lever is pivoted downwardly.

In another embodiment of the invention, the handle is configured as a plug-in part, such as for example a handle button, which can be axially plugged into the housing as far as the end position and which cooperates with the two inner lever arms when inserted.

The housing can advantageously be composed of two housing halves which are either two separate individual parts or are integrally connected together by means of a film hinge.

In a further aspect, the invention also relates to a furniture arrangement with two furniture parts which abut one another at an angle, preferably at right-angles, and which are fastened together by means of the above-described fitting, wherein the one first furniture part has an edge-side open bore and the other second furniture part has a surface-area bore, and wherein the housing of the fitting is inserted into the bore of the first furniture part and the outer lever arms of the fitting are spread apart in the surface-area bore of the second furniture part.

Further advantages of the invention emerge from the description, the claims and the drawing. Similarly, the aforementioned features described below in more detail can be used per se or combined together in any combinations. The embodiments shown and described are not to be understood as a definitive list but rather have an exemplary character for illustrating the invention.

### BRIEF DESCRIPTION OF THE DRAWINGS

In the drawing:

FIG. 1 shows a fitting according to the invention in an exploded view;

FIGS. 2a, 2b show the fitting according to the invention in a starting position (FIG. 2a) and in an end position (FIG. 2b);

FIGS. 3a, 3b show a cross section of the fitting according to the invention in the starting position (FIG. 3a) and in the end position (FIG. 3b);

FIG. 4 shows a furniture arrangement with the fitting according to the invention; and

FIGS. 5, 6 show two further embodiments of the fitting according to invention in each case in the starting position.

### DETAILED DESCRIPTION OF THE PREFERRED EMBODIMENTS

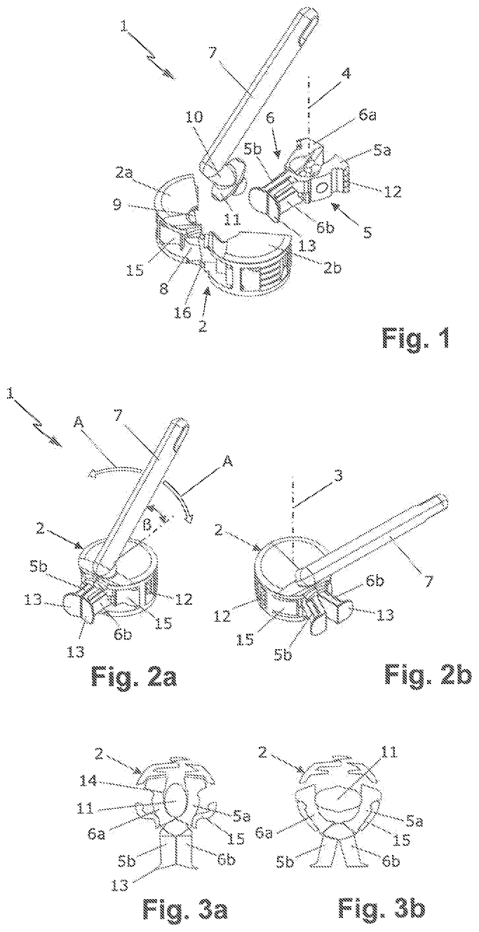

The fitting 1 shown in FIGS. 1, 2a, 2b serves for fastening, in order to connect two parts, and comprises a cup-shaped housing 2, two double-armed levers 5, 6 which are connected in an articulated manner about an axis 4 running, in the housing 2, parallel to the cup axis 3, as well as a handle in the form of a double-armed pivot lever 7 which can be moved from a starting position (FIG. 2a) into an end position (FIG. 2b).

The two levers 5, 6 are connected together in a scissors-like manner and in each case have an inner lever arm 5a, 6a which is arranged in the housing 2 and an outer lever arm 5b, 6b which protrudes outwardly out of the housing 2 through a housing opening 8 on the circumferential side. The housing 2 has in its upper housing front face in the figures a round bearing opening 9 in which a shaft 10 of the pivot lever 7 is rotatably mounted, in order to rotate the pivot lever 7 from the starting position, shown in FIG. 2a, by approx. ±90° about an axis parallel to the axes 3, 4 into the end position, shown in FIG. 2b (direction of arrow A). As shown in FIG. 2a, the pivot lever 7, which is at an angle relative to the shaft axis, in its starting position additionally can be pivoted up by an angle β (for example 45°) relative to the upper housing front face.

An actuating element is located at a lever end of the pivot lever 7 extending into the housing interior, said actuating element being in the form of a spreading element 11 with an outer contour or spreading contour which is not circular relative to the shaft axis but elliptical in this case, and which rises radially outwardly in the rotational direction A. The spreading element 11 is arranged in the housing 2 between the inner faces of the inner lever arms 5a, 6a, which face one another, in order to spread apart the two inner lever arms 5a, 6a and thereby also the two outer lever arms 5b, 6b further and further by rotating the pivot lever 7 from the starting position into the end position. In the end position of the pivot lever 7, the two outer lever arms 5b, 6b are thus spread apart further than in the starting position in which the two outer lever arms 5b, 6b bear against one another back-to-back, i.e., are closed. The inner lever arms 5a, 6a have, at their free ends on the outer face, teeth 12 which in the end position protrude outwardly from the housing 2. The outer lever arms 5b, 6b have, at their free ends protruding from the housing 2, in each case an outwardly angled wedge nose 13.

In order to hold the spreading element 11 and thereby the pivot lever 7 in the end position, optionally the inner lever arms 5a, 6a, as shown in FIGS. 3a, 3b, in each case can have on the inner face a recess 14 in which the spreading element 11 is latched in the end position. The housing 2 can optionally also have two restoring springs in the form of two circumferential tabs 15 which face one another in the housing circumferential direction and which are elastically deflected outwardly or elastically deformed into a round outer contour by the inner lever arms 5a, 6a when the pivot lever 7 is rotated from the starting position into the end position. When rotated from the starting position into the end position, the pivot lever 7 is rotated into the end position counter to the elastic restoring force of the circumferential tabs 15 and thus is pretensioned into the starting position.

The housing 2 can be composed of, for example, two housing halves 2a, 2b which are either two separate individual parts or, as shown in FIG. 1, integrally connected together by means of a film hinge 16.

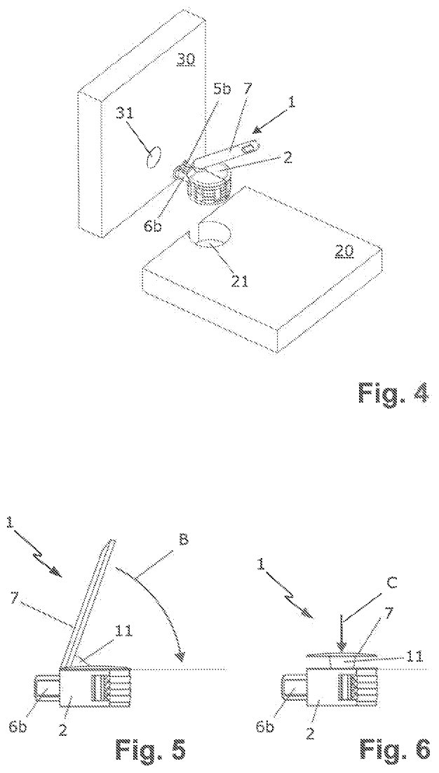

FIG. 4 shows a furniture arrangement with two furniture parts 20, 30 which abut one another at right-angles and which are fastened together by means of the fitting 1. The mounting steps required therefor are as follows:
The pivot lever 7 of the fitting 1 is located in its (central) starting position and is lifted upwardly at the angle β.
The housing 2 of the fitting 1 is inserted into a bore 21 of the first furniture part 20 which is open toward the front face of the furniture on the edge side. The two outer lever arms 5b, 6b protrude from the front face of the furniture and, since they are not spread apart from one another, together form a pin which is inserted in a surface-area bore 31 of the second furniture part 30.
Finally, the pivot lever 7 is rotated by approx. 90° in the one or in the other direction into the starting position, and at the same time pivoted downwardly until it bears in parallel against the upper housing front face in the end position. In the end position, the spreading element 11 is latched in the recesses 14. The inner lever arms 5a, 6a and the outer lever arms 5b, 6b are spread apart by the spreading element 11, whereby, on the one hand, the teeth 12 are pressed into the bore wall of the open-edge bore 21 and, on the other hand, the wedge noses 13 are pressed into the bore wall of the surface-area bore 31. The two furniture plates 20, 30 are additionally pulled together by the wedge noses 13 until they bear against one another without gaps.

The fitting 1, shown in FIG. 5, differs from the fitting of FIGS. 1 and 2 in that here the pivot lever 7 is single-armed and is mounted so as to be pivotable about an axis running parallel to the upper housing front face, in that the actuating element 11 is arranged on the lower face of the pivot lever 7, and in that in the starting position shown in FIG. 5 the pivot lever 7 is lifted by approx. 70° relative to the upper housing front face. When pivoting the pivot lever 7 downwardly into the end position (direction of the arrow B), in which it bears in parallel against the upper housing front face, the actuating element 11 spreads apart the two inner lever arms 5a, 6a and thus also the two outer lever arms 5b, 6b. To this end, the actuating element 11 and/or the outer faces of the inner lever arms 5a, 6a can have corresponding oblique surfaces which convert the lowering movement of the actuating element 11 into a spreading movement of the inner lever arms 5a, 6a.

The fitting 1, shown in FIG. 6, differs from the fitting of FIGS. 1 and 2 in that here the handle is configured as a plug-in part 7 which, from the starting position shown (direction of arrow C), is axially pressed into the housing 2 as far as the end position. The actuating element 11 is located on the lower face of the plug-on part 7 and is configured, for example, as a downwardly tapering cone which, when the plug-in part 7 is pressed in, spreads apart the two inner lever arms 5a, 6a and thus also the two outer lever arms 5b, 6b.

Instead of crossing one another in a scissors-like manner, in other embodiments, not shown here, the two levers can be connected together in the manner of spreading tongs, i.e., not crossing one another. In this case, in the starting position the inner lever arms are open and the outer lever arms are closed. The actuating element of the handle has a pressing contour which cooperates with the outer faces of the inner lever arms, which face away from one another, in order to press together the two inner lever arms when the handle is moved into the end position and thereby to spread apart the outer lever arms.

What is claimed is:

1. A fitting for connecting two parts, comprising:
a cup-shaped housing for insertion into an open-edge bore in the one part;
two double-armed levers which are connected in an articulated manner about an axis running, in the housing, parallel to the cup axis and which each have an inner lever arm which is arranged in the housing and an outer lever arm which projects outwards beyond the circumference of the housing and is intended for engaging in a surface-area bore in the other part; and
a handle which can be moved from a starting position into an end position and has an actuating element for rotating the inner lever arms in relation to one another wherein the two outer lever arms are spread further apart in the end position of the handle than in the starting position.

2. The fitting as claimed in claim 1, wherein the two double-armed levers are connected together in a scissors-like manner and in that the actuating element cooperates with the inner faces of the inner lever arms, which face one another, in order to spread the two inner lever arms further apart in the end position of the handle than in the starting position.

3. The fitting as claimed in claim 1, wherein the two double-armed levers are connected together in the manner of spreading tongs and in that the actuating element cooperates with the outer faces of the inner lever arms, which face away from one another, in order to press the two inner lever arms further together in the end position of the handle than in the starting position.

4. The fitting as claimed in claim 1, wherein the actuating element has a spreading contour for spreading apart the two inner lever arms, or a pressing contour for pressing together the two inner lever arms.

5. The fitting as claimed in claim 1, wherein the outer lever arms have at their free ends protruding from the housing in each case on the outer face at least one outwardly angled wedge nose.

6. The fitting as claimed in claim 1, wherein the inner lever arms have at their free ends in each case on the outer face at least one tooth which in the end position protrudes outwardly from the housing.

7. The fitting as claimed in claim 1, wherein the housing has at least one circumferential tab, in particular two circumferential tabs which face one another in the housing circumferential direction and which are elastically deflected or elastically deformed outwardly by the inner lever arms when the handle is moved from the starting position into the end position.

8. The fitting as claimed in claim 1, wherein the inner lever arms have in each case on the inner face a latching recess or a latching projection in order to latch the actuating element in the end position.

9. The fitting as claimed in claim 1, wherein the handle is configured as a pivot lever which is mounted on the housing so as to be rotatable from the starting position into the end position.

10. The fitting as claimed in claim 9, wherein the pivot lever is configured to be double-armed and is mounted on the housing so as to be rotatable about an axis parallel to the rotational axis of the two levers.

11. The fitting as claimed in claim 10, wherein in the starting position of the handle the pivot lever is lifted up by an angle (β) relative to the housing front face.

12. The fitting as claimed in claim 9, wherein the pivot lever is configured to be single-armed and is mounted on the housing so as to be rotatable about an axis at right-angles to the rotational axis of the two levers.

13. The fitting as claimed in claim 1, wherein the handle is configured as a plug in-part which can be axially plugged into the housing as far as the end position.

14. The fitting as claimed in claim 1, wherein the housing is composed of two housing halves which are integrally connected together by means of a film hinge.

15. A furniture arrangement with two furniture parts which abut one another at an angle and which are fastened together by means of the fitting as claimed in claim 1, wherein the one first furniture part has an edge-side open bore and the other second furniture part has a surface-area bore, and wherein the housing of the fitting is inserted into the bore of the first furniture part and the outer lever arms of the fitting are spread apart in the surface-area bore of the second furniture part.
